(19) United States
(12) Patent Application Publication
(10) Pub. No.: US 2007/0023943 A1
(43) Pub. Date: Feb. 1, 2007

(54) Stripping titanium-based wear coatings

(76) Inventors: Dominick John Forenz, Hammondsport, NY (US); Julie Ann Kendall, Elkland, PA (US)

Correspondence Address: CORNING INCORPORATED, SP-TI-3-1, CORNING, NY, 14831, US

(21) Appl. No.: 11/193,786

(22) Filed: Jul. 28, 2005

(51) Int. Cl. B28B 7/04

(52) U.S. Cl. 264/39; 252/79.1

(57) ABSTRACT

A method of removing a titanium-based coating from an extrusion die includes immersing the extrusion die in a stripping bath containing a removal solution which comprises hydrogen peroxide, a first acid which accelerates stripping of the titanium-based coating from the extrusion die, and a second acid which protects the stripping bath from loss of hydrogen peroxide activity.

### BACKGROUND OF THE INVENTION

The invention relates generally to wear-coated extrusion dies for making ceramic products such as ceramic honeycombs, and more particularly to processes for the removal of titanium-based wear coatings from extrusion dies and other complex tooling.

Honeycomb structures used to catalytically treat or remove solid particulates from fluids such as combustion engine exhaust gas streams are presently made in high volumes by a ceramic extrusion process. FIG. 1 shows a vertical cross-section of an extrusion die 100 suitable for the manufacture of a honeycomb structure. A central region 102 of the extrusion die 100 includes an array of discharge slots 104 which define an array of pins 106. The central region 102 includes an array of central feedholes 108 extending from an inlet face 110 of the die 100 to the array of discharge slots 104. The central feedholes 108 are used to supply batch material to the discharge slots 104. The peripheral region 112 of the extrusion die 100 provides a mounting surface 114 for a skin forming mask 116. The peripheral region 112 includes feedholes 118 for feeding batch material into a space 120 around the central region 102 of the extrusion die 100. The extrusion die 100 and the skin forming mask 116 cooperate to define the shape and thickness of the honeycomb structure. Batch material is extruded through the discharge slots 104 to form the interconnecting porous walls of the honeycomb structure. Batch material is extruded through the space 120 between the skin forming mask 116 and the extrusion die 100 to form the skin of the honeycomb structure.

The extrusion die 100 is typically formed of a metal such as steel. A typical batch material for forming a honeycomb structure by extrusion through such a die includes ceramic materials such as alumina or silicon carbide that, even when mixed with a binder/plasticizer, are quite abrasive. It is common to apply a wear-resistant coating on the pins 106 and within the feedholes 108 of the extrusion die 100 to reduce abrasion of the pins 106 as the batch material is forced through the discharge slots 104. The thickness of the wear-resistant coating can also be used to adjust the width of the discharge slots 104.

A typical wear-resistant coating is a titanium-based material with excellent abrasion resistance, such as TiC, TiN, or TiCN. The wear-resistant coating is applied on the extrusion die 100 using processes such as physical vapor deposition or chemical vapor deposition. The extrusion die 100 can be regenerated by re-applying the wear-resistant coating when the coating is worn, or when it is desired to adjust the width of the discharge slots 104. This is best accomplished through processes involving first stripping the worn coating from the die by physical or chemical means, followed by reapplying a titanium-based coating on the extrusion die.

The removal of titanium-based wear coatings from steel tooling by chemical stripping is well known throughout the coating and tool and die industries. However, unique problems are encountered in the application of the conventional processes to the stripping of honeycomb extrusion dies because of the extremely small openings and complicated internal geometries characteristic of such dies.

Conventional extrusion die stripping generally involves immersing the extrusion die in a removal solution provided in a stripping bath, most preferably with movement of the extrusion die continuously inside the stripping bath so that “fresh” removal solution reaches the internal parts of the extrusion die. Aqueous hydrogen peroxide solutions are commonly employed in stripping baths for titanium-based wear coatings, and have been employed for the stripping of these extrusion dies.

One prior art die stripping process uses an aqueous removal solution containing 35% (vol.) hydrogen peroxide and 1% (vol.) phosphoric acid at 140° C. More generally, U.S. Patent Application No. 2004/0110654 (Matsumoto et al.) describes a method of removing titanium-based coating film or oxide of titanium using a mixture of an acid, such as nitric acid or sulfuric acid, and hydrogen peroxide at more moderately elevated temperatures. The prior use of removal solutions including 60 to 70% nitric acid as a main component is also noted. U.S. Pat. No. 6,432,219 describes a method of removing TiAlN using an alkaline solution containing hydrogen peroxide, at least one base, and at least one of an acid and a salt of an acid selected from the group consisting of phosphates, phosphonates, and phosphonic acids.

Among the problems encountered with prior art methods and materials for stripping titanium-based wear coatings from complex structures such as honeycomb extrusion dies are long removal times, possible damage to the die steel substrate and particularly the relatively fragile pin structure, with long immersions, rapid loss of stripping solution effectiveness, and chemical instability of the stripping solution. The need to use relatively high bath temperatures with baths containing relatively high concentrations of hydrogen peroxide are also matters of concern from the standpoints of both safety and cost. Thus there remains a need for improved methods of removing titanium-based coatings from extrusion dies, particularly those having very small pins and discharge slots and complicated internal geometries, such as those used to make honeycomb structures having cellular densities between about 100 and 1200 cells/in² (about 15 to 180 cells/cm²). Such improved methods will preferably be fast, extend the life of the stripping bath, and produce stripped die surfaces that allow effective recoating of the extrusion die.

### SUMMARY OF THE INVENTION

In one aspect, therefore, the invention provides a family of improved solutions for removing titanium-based coatings from complex metal tooling such as honeycomb extrusion dies. The solutions of the invention generally include hydrogen peroxide as the active stripping component, together with a first acid which accelerates stripping of the titanium-based coating from the extrusion die by the hydrogen peroxide, and a second acid which protects the stripping bath from premature loss of hydrogen peroxide activity. The remaining component of these solutions is normally water.

Based on these improved solutions, the invention further provides an improved method for removing titanium-based wear coatings from structures of complex geometry such as extrusion dies. Generally characterized, that method comprises the step of immersing the extrusion die in a stripping bath containing a removal solution such as above described, i.e., comprising hydrogen peroxide, a first acid which accelerates stripping of the titanium-based coating from the extrusion die, and a second acid which protects the stripping bath loss of hydrogen peroxide activity. To insure rapid and essentially uniform coating removal from all surfaces of the die or other structure, provisions are made to insure circulation of the removal solution over and through the structure, for example by continuously moving the die in the solution or flowing the solution through the die.

Other features and advantages of the invention will be apparent from the following description and the appended claims.

### BRIEF DESCRIPTION OF THE DRAWINGS

FIG. 1 shows a prior-art extrusion die for making a honeycomb structure.

FIG. 2 shows rates of stripping titanium-based coatings from extrusion die samples for a number of stripping processes and stripping solutions

FIG. 3 shows stripping rates for the removal of a TiCN-wear-coated honeycomb extrusion die of high cell density using a removal solution according to an embodiment of the invention.

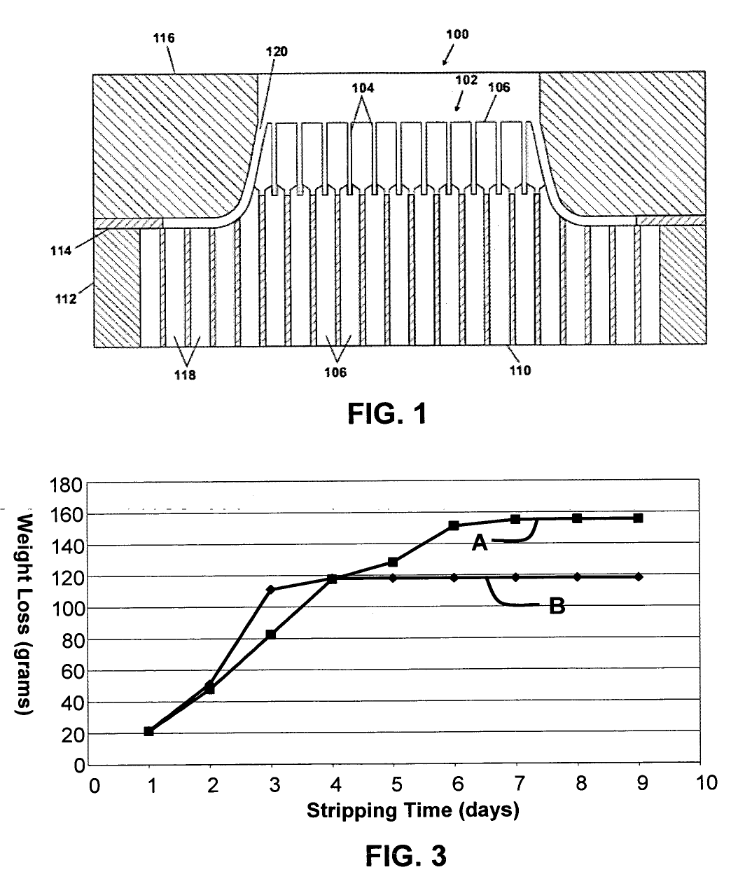

### DETAILED DESCRIPTION OF THE INVENTION

To provide a more thorough understanding of the invention, the following detailed descriptions are presented primarily with reference to specific or preferred embodiments. It will be apparent from those descriptions that not all details must be practiced, and that some well-known features and/or process steps have not been described in detail, in order to avoid unnecessarily obscuring the invention.

As noted above, it is an important aspect of the invention to provide a family of improved removal solutions for removing titanium-based wear coatings, particularly including wear coatings composed of TiN, TiCN, and TiC, from an extrusion die. The removal solutions of the invention are most preferably used in an immersion-with-movement process to remove the titanium-based coating from the extrusion die, since as for any coated steel article of complex internal geometry (articles incorporating a multiplicity of internal void spaces bounded by internal surfaces), movement of the solution across internal as well as external surfaces is beneficial.

The key components of the removal solution are hydrogen peroxide, a stripping accelerator, and a bath preservative. The stripping accelerator and bath preservative must be selected to be compatible with the base material of the extrusion die as well as effective to prolong the useful life of the bath. Suitable stripping accelerators include nitric and sulfuric acids, with the preferred stripping accelerator in most formulations being nitric acid.

The bath preservative can be any material that can protect the stripping bath from premature loss of hydrogen peroxide activity. Peroxide activity loss can be accelerated by the introduction of oxidizable contaminants into the bath. A preferred bath preservative is phosphoric acid, although commercial bath additives to extend hydrogen peroxide stripping bath service life are also available and can be additionally or alternatively used.

The stripping accelerator and the bath preservative must work together compatibly in order provide a removal solution capable of efficiently removing the titanium-based coating from the extrusion die while extending the life of the stripping bath. Unexpectedly, the inventors have found that an advantageous reduction in oxide buildup on the stripped die surfaces is observed with removal solutions containing hydrogen peroxide, nitric acid, and a bath preservative such as phosphoric acid, in comparison to a removal solution containing hydrogen peroxide with phosphoric acid alone or hydrogen peroxide with nitric acid alone.

A range of concentrations of hydrogen peroxide, stripping accelerator and bath preservative can be employed in the preparation of the stripping solutions of the invention. Examples of preferred solutions include those comprising 17 to 50% by volume of hydrogen peroxide, 1 to 5% by volume of a stripping accelerator, and 0.5 to 5% by volume of a bath preservative, with the remainder water. These solutions can be employed at any suitable solution temperature in the range from about room temperature to 140° F. (60° C.), preferably in a range from 40 to 140° F. (5-60° C.), and more preferably in a range from 100 to 120° F. (38-50° C.). Solutions incorporating 30-40% by volume of hydrogen peroxide, 1-2% by volume of a stripping accelerator, 0.5-1% by volume of a bath preservative, and the remainder water are particularly effective in the preferred temperature range.

In one embodiment of these preferred solutions, the stripping accelerator is nitric acid or sulfuric acid and the bath preservative is phosphoric acid. In a particularly preferred embodiment, the stripping accelerator is nitric acid. It has been observed that the nitric acid in hydrogen peroxide/phosphoric acid results in a faster stripping rate than when hydrogen peroxide and phosphoric acid are used alone. It has also been observed that the phosphoric acid in hydrogen peroxide/nitric acid results in longer bath life than when hydrogen peroxide and nitric acid are used alone. For example, the addition of phosphoric acid to hydrogen peroxide/nitric acid solution typically extends the bath life from about 2 to 3 days to about 4 to 5 days.

The invention further includes a method of removing a titanium-based coating from a honeycomb extrusion die using a stripping bath of consisting of a removal solution according to an embodiment of the invention. In one embodiment, this involves adding appropriate amounts of hydrogen peroxide, stripping accelerator, e.g., nitric acid, and bath preservative, e.g., phosphoric acid, to the stripping bath to achieve the desired concentrations. The method further includes mounting the extrusion die in a holder, such as a rack, and immersing the extrusion die in the removal solution in the stripping bath. Multiple extrusion dies may be mounted in holders and immersed in the solution to allow simultaneous stripping of multiple extrusion dies. The method further includes activating a heating/cooling system to maintain the removal solution within a desired temperature range. The temperature and bath chemistry may be monitored and used to adjust the heating/cooling system.

During stripping, the extrusion die is preferably moved continuously inside the removal solution. For example, the holder for the extrusion die may be disposed relative to the stripping bath such that it is movable inside the stripping bath. The holder may be movable manually or automatically, e.g., through the use of a suitable actuator. In one example, the holder is moved up and down continuously over a stroke length of several inches in the removal solution. This movement ensures that “fresh” solution enters the internal parts of the extrusion die, and it aids in the removal of oxidized coating from the extrusion die by erosion and removal of dislodged coating material from the internal parts of the die. A useful procedure and apparatus for practicing die immersion with movement in the stripping solutions of the invention are disclosed in U.S. patent application Ser. No. 10/978,124 filed Oct. 29, 2004 for a METHOD AND APPARATUS FOR PLATING EXTRUSION DIES, that application being expressly incorporated herein by reference in its entirety.

Table 1 below shows chemical composition for various coating removal solutions, both within and outside of the scope of the invention. Coating stripping rates are reported in terms of the sample weight losses observed during laboratory testing of the solutions on small TiCN-wear-coated stainless steel extrusion die sections. The proportions of active coating constituents present in the stripping solutions are reported in parts by volume; the remainder of each of the solution examples consists of deionized water.

Also shown in Table 1 are bath temperatures and average stripping rate for TiCN stripping processes using these removal solutions. Average stripping rates are calculated from the total sample weight losses and processing times. The stripping times can vary from sample to sample depending upon coating thickness as well as the stripping rate. Where rapid stripping rates are observed, only short treatments are required to achieve complete coating removal, at which time the stripping processes are terminated.

TABLE 1
TiCN STRIPPING PROCESSES

| | | Phos- | | | | Average |
|---|---|---|---|---|---|---|
| | Hydrogen | phoric | Nitric | Sulfuric | Bath | Stripping |
| Process | Peroxide | Acid | Acid | Acid | Temp | Rate |
| No. | (vol %) | (vol %) | (vol %) | (vol %) | (in ° F.) | (g/hr) |
| 1 | 35 | 1 | 0 | 0 | 140 | 0.026 |
| 2 | 35 | 1 | 0 | 0 | 120 | 0.033 |
| 3 | 17.5 | 1 | 0 | 0 | 120 | 0.031 |
| 4 | 17.5 | 0 | 0 | 0 | 70 | 0.003 |
| 5 | 35 | 0 | 0 | 1 | 120 | 0.030 |
| 6 | 35 | 0 | 1 | 0 | 120 | 0.028 |
| 7 | 35 | 0 | 1 | 0 | 70 | 0.016 |
| 8 | 35 | 0 | 2 | 0.5 | 120 | 0.098 |
| 9 | 35 | 1 | 0 | 0 | 95 | 0.006 |
| 10 | 35 | 2 | 0 | 0 | 120 | 0.010 |
| 11 | 35 | 2 | 0 | 0 | 95 | 0.005 |
| 12 | 35 | 1 | 2 | 0 | 120 | 0.025 |
| 13 | 35 | 1 | 2 | 0 | 120 | 0.022 |
| 14 | 35 | 0.5 | 2 | 0 | 120 | 0.033 |
| 15 | 35 | 1 | 1 | 0 | 120 | 0.035 |

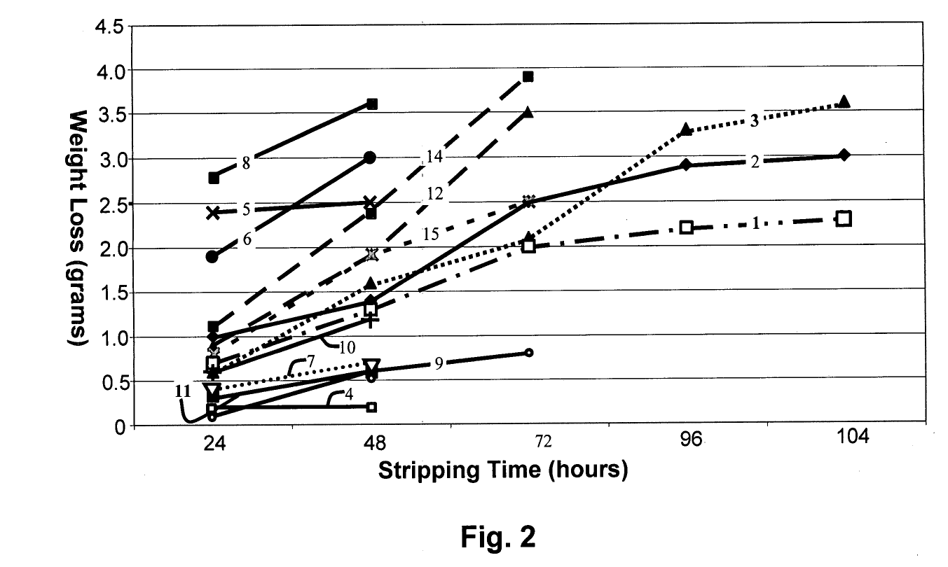

Stripping rate data from the tests reported in Table I above are presented in a graphical format in FIG. 2 of the drawings, which plots wear coating weight loss versus time for the small TiCN wear-coated samples treated with solutions from Table 1. Curves corresponding to the various Table 1 examples are labeled with their respective Table 1 Process numbers.

As the data plotted in FIG. 2 generally reflect, relatively low 24-hour weight losses, corresponding to relatively low stripping rates, are observed with solutions such as those of Processes 1-4, 7, 9 and 11 that contain no accelerator, or that are carried out at low bath temperatures. Substantially higher 24-hour weight losses are seen in the case of Processes 5, 6 and 8 that employ nitric or sulfuric acid stripping accelerators, but those processes do not utilize bath stabilizers and so the baths will exhibit a more rapid loss in stripping efficiency over time. Processes 12-15 from Table 1, while somewhat lower in 24-hour stripping rate than processes employing the stripping accelerators alone, have been found to provide the best combination of bath stability and efficient coating removal over time, in some cases being capable of substantially complete coating removal from these small test samples within a stripping treatment time of 72 hours.

Some variability in the weight loss data presented in Table 1 and FIG. 2 likely arises from the fact that a metal oxidation reaction can interfere and/or compete with the coating removal reactions occurring in these stripping processes, particularly at higher processing temperatures. We have found that useful reductions in coating removal times employing the removal solutions of the invention can be achieved through the periodic use of an electrocleaning procedure wherein the die is treated with an electrocleaning solution while an electrical potential between the die and the solution is adjusted so that the die is anodic in the electrical circuit. A suitable electrocleaning solution consists of a mixture of water with a commercially available electrocleaner such as Meta-Kleen JS 700, that electrocleaner being present in the solution at a concentration of 5-20% by volume. These are generally basic solutions (pH>7). The anodic potential of the die is suitably maintained in the range of 3-6 volts for treatments of up to three minutes in the cleaning solution. Reductions in coating removal times on the order of days can be achieved through the use daily electrocleaning as above described.

FIG. 3 presents data plotting representative weight loss versus time for the stripping of two full size TiCN-wear-coated honeycomb extrusion dies in accordance with the invention. The removal solution used to strip these dies contains 35% by volume hydrogen peroxide, 0.5% by volume phosphoric acid, 2% by volume nitric acid and the remainder water. The dies being treated feature very small feedholes and pins, being designed for the extrusion of ceramic honeycombs having a cell density of about 135 cells/cm² of honeycomb cross-section with channel walls of about 0.05 mm thickness. The stripping process employed to achieve results such as illustrated in FIG. 3 includes immersion with movement in a 20 Liter bath maintained at a bath temperature of about 120° F. Average stripping rates of 0.981 g/hr and 0.948 g/hr from full size extrusion dies are observed to result from this process.

In conclusion, we have found that the removal solutions of the invention typically increase the stripping rate while at the same time extending the life of the stripping bath and reducing oxide buildup on the stripped substrates. Further, the removal solution uses components such as nitric acid that are readily available, and those components are compatible with the base material of extrusion dies. The removal solution can be used to effectively remove titanium-based coatings at varying temperatures.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A method of removing a titanium-based coating from an extrusion die, comprising:
immersing the extrusion die in a stripping bath containing a removal solution which comprises hydrogen peroxide, a first acid which accelerates stripping of the titanium-based coating from the extrusion die, and a second acid which protects the stripping bath loss of hydrogen peroxide activity.

2. The method of claim 1, wherein the first acid is nitric acid or sulfuric acid.

3. The method of claim 2, wherein the second acid is phosphoric acid.

4. The method of claim 1, wherein the removal solution is maintained at a temperature ranging from room temperature to 140° F.

5. The method of claim 1 wherein the removal solution is circulated over and through the extrusion die.

6. The method of clam 1 wherein the removal solution comprises 17 to 50% by volume hydrogen peroxide, 1 to 5% by volume of the first acid, and 0.5 to 5% by volume of the second acid.

7. The method of claim 1, wherein the titanium-based coating comprises one selected from the group consisting of TiC, TiN, and TiCN.

8. A solution for removing titanium-based coating from an extrusion die by immersion in a stripping bath, comprising:
hydrogen peroxide;
a first acid which accelerates stripping of the titanium-based coating from the extrusion die; and
a second acid which protects the stripping bath from loss of hydrogen peroxide activity.

9. The solution of claim 8, wherein the first acid is nitric acid or sulfuric acid.

10. The solution of claim 9, wherein the second acid is phosphoric acid.
